(19) United States
(12) Patent Application Publication
(10) Pub. No.: US 2012/0060620 A1
(43) Pub. Date: Mar. 15, 2012

(54) DEVICE FOR AN AXIAL LOAD GAUGE

(75) Inventors: Nicholas James Caunter, Wantage Oxfordshire (GB); David Matthew Lynch, Wantage Oxfordshire (GB); Stephen Robert Arnell, Swindon Wiltshire (GB); Ian Flude, Wantage Oxfordshire (GB); John Gordon Skidmore, Wantage Oxfordshire (GB)

(73) Assignee: CROWN PACKAGING TECHNOLOGY, INC., ALSIP, IL (US)

(21) Appl. No.: 13/321,582

(22) PCT Filed: May 5, 2010
(86) PCT No.: PCT/EP10/56116

§ 371 Date: Nov. 21, 2011

(30) Foreign Application Priority Data
May 21, 2009 (EP) 09160862.0

(51) Int. Cl. G01N 3/00

(52) U.S. Cl. 73/788

(57) ABSTRACT

The invention relates to a device for investigating the statistical variability of an axial load gauge. The device is inserted into an axial load gauge and a load is gradually applied. At a preset load, a mechanism within the device controllably collapses and the applied load is safely transmitted through the structure of the device. A comparison of the load measured on the device load cell against that measured on the gauge load cell facilitates calculation of the repeatability and reproducibility of the axial load gauge. The test is non-destructible and highly repeatable; it permits comparison of load measurements made on different axial load gauge types and in different factories.

### TECHNICAL FIELD

This invention relates to a device for an axial load gauge, for example a device that is used to investigate the statistical variability of such a gauge. Furthermore, the gauge is primarily intended for use in the metal packaging industry, on containers used for food and beverage products.

### BACKGROUND ART

A customer critical performance criterion of much packaging, e.g. containers such as metal cans and plastic bottles, is its axial load performance. For cans, it is relevant to container stacking, transport, filling and seaming. To demonstrate conformance to specification, samples are tested in a gauge that applies an axial load by, for example, a pneumatic cylinder or a lead-screw driven by a motor. The force is measured and the point of collapse is seen as a sudden drop in load. The hardware or software of the gauge detects the point of collapse and returns a value for the collapse load. While being tested the can behaves as a stiff spring, deforming in an elastic manner, until the point of collapse when permanent “plastic” deformation occurs. The test is a destructive test and since the properties of the samples vary in some degree, checking the repeatability of the test results is difficult.

There is therefore a need for separating the variability of samples from the variability of the gauge.

The variability of a gauge has two major components, namely repeatability and reproducibility. The repeatability of a gauge is the capability of the gauge to give consistent measurement no matter how many times the same operator of the gauge repeats the measurement process. The reproducibility of a gauge is the ability of the same gauge to give consistent measurement readings regardless of the operator who performs the measurements.

### DISCLOSURE OF THE INVENTION

Accordingly, there is provided a device for an axial load gauge comprising an interface for interfacing to the axial load gauge, a collapsible mechanism and a load cell, whereby in use when a load is applied to the device, the applied load is transmitted through the device until a preset load value is reached, thereby activating collapse of the collapsible mechanism.

This device facilitates calculation of the statistical variability of the measurement system by rendering substantially constant the individual effect of a sample on the load performance, for example due to anisotropic material properties or the presence of defects. During the test, the device remains intact and undamaged, with the result that a load may be applied repeatedly onto the same device. This device can then be used over and over again to monitor the same gauge at different times or equally to investigate the or any bias in measurement readings caused by using an alternative type of axial load gauge. As such, this device will ultimately permit an accurate comparison of axial load performances of products originating from various packaging manufacturers. This is because once the variability of a gauge is established, axial load data on the samples, e.g. beverage cans, usually used in these gauges becomes more meaningful.

In one particular embodiment, the device further comprises a supporting structure, which accommodates at least the collapsible mechanism. This supporting structure may be adapted to take any appropriate form, for example, a piece of packaging such as a beverage container. When a device is configured, in terms of layout and materials selection, specifically for a particular type of axial load gauge, the supporting structure of the device can be modified to reflect this, especially if modified aesthetically. At a glance, an operator would be able to tell for which gauge the device was currently configured.

Preferably the collapsible mechanism includes a fluid bearing or a rolling element bearing. The advantage of these types of bearing for this particular application, is that they have a low coefficient of friction with the effect that the applied load is transmitted to the load cell with a minimum amount of resistance, therefore reducing the mathematical error associated with the test result. Bearings that operate with a sliding motion, such as traditional plain bearings, will typically have a greater coefficient of friction than those that operate with a rolling motion and so they would not be particularly suitable for use as part of the collapsible mechanism.

In one preferred arrangement, the collapsible mechanism includes a plurality of ball bearings or roller bearings. The advantage of these bearings is that they are simple and relatively inexpensive to manufacture or to purchase compared to fluid bearings.

Ideally, the collapsible mechanism will consist of a plurality of roller bearings, held in place by an axial support. This arrangement advantageously keeps the number of components in the device to a minimum, reducing its cost and weight.

The inclusion of lubrication within any of the bearings, those involved with the collapsible mechanism and those used elsewhere within the device, is optional. On the one hand, its absence is desirable to avoid problems such as maintenance issues and fluid leaks. The device would consequently be lighter and cheaper to manufacture. However, its inclusion would prolong the useful life of any internal bearing components. In choosing whether or not to include lubrication, the expected life and usage environment of the device should be taken into consideration. Bearing materials are currently available that forego the need for any lubrication, for example, plastics with slip additives.

In a further preferred embodiment, the device load cell is in communication with the collapsible mechanism. The advantage of this arrangement is that the load can be transmitted directly through the device load cell thereby avoiding any losses in load due to friction.

A similar advantage can be gained from locating the device load cell outside of the supporting structure, contiguous one of the or any external surfaces of the supporting structure. This optimum arrangement effects the most accurate measurement reading by the axial load gauge of the applied load.

In an additional embodiment, the device further comprises a compliant element interposed the load-cell and the collapsible mechanism. With the inclusion of a compliant element, the device is adapted for use on an axial load gauge that applies a load to the sample under test by effecting a displacement, for example a lead-screw driven device. A regular metal container taken from a container-making production line behaves like a spring, in that when an axial load is applied, the container will flex before it crumples, displacement of the container being directly proportional to the applied load. If a lead-screw type gauge were to apply the same load to the device, the force would climb very steeply with no displacement and so the gauge would not simulate a real can effectively. The function of the compliant element is to introduce the small amount of displacement that a real container would experience before its point of collapse. The compliant element could be, for example, a spring or a predictably flexible plastic block. The spring rating of that element is such that the device is able to simulate effectively the desired sample under test. To clarify: the compliant element used in a device for simulating the collapse of steel containers would have a different spring rating to one used for simulating the collapse of aluminium containers. These spring ratings would be different again to that of a compliant element used to simulate the collapse of a plastic bottle.

If the supporting structure takes the form of a chamber with a displaceable wall end, then in one preferred embodiment it is constructed of metal, for example, carbon steel. Metal is a material with an inherently high resistance to load deformation compared to other rigid materials such as plastic. In practice, this means that if the axial load gauge fails in any way and the applied load of the gauge becomes potentially dangerous and damaging, the device is able to withstand the load. Additionally, a sturdy chamber with a displaceable wall end will protect the inner components from damage during transit and normal handling within a factory environment. Furthermore, such a metal supporting structure will react to changes in temperature in a more uniform manner than for example plastic. In practice, the device must be acclimatised to room temperature for up to an hour before use. This permits the internal components of the device, especially any electrical components, to stabilise at room temperature.

It is understood that the layout of the device component parts may be adapted to permit the device to be inserted into an axial load gauge, whether vertically or horizontally, for ease of use.

Equally, it is understood that the supporting structure and any of the other device components may be configured to adapt the device for use in axial load gauges typically used for other packaging formats, such as yoghurt pots, metal oil drums, plastic bottles and Tetra Pak® style beverage cartons etc.

There is also herein provided a method of investigating the variability of an axial load gauge by: i. Inserting the device into the axial load gauge, ii. Applying a load onto the device until collapse at a preset load, iii. Measuring the load returned by the gauge when the device collapses, iv. Comparing the collapse loads returned by the gauge with the preset collapse load of the device, v. Repeating steps ii-iv as required.

In one preferred method, the same operator of the machine carries out steps i-v as this will generate load data that can be used to assess the repeatability of the axial load gauge.

In a second preferred method, the steps are repeated by at least two different operators. This will generate load data that can be used to assess the reproducibility of the axial load gauge.

Steps ii-v may equally be automated and be carried out by a machine instead of a human operator without departing from the spirit of the invention.

### BRIEF DESCRIPTION OF DRAWINGS

The present invention will now be described, by way of example only, with reference to the accompanying drawings in which:

FIG. 1 is a schematic diagram of a preferred embodiment of the invention, in an uncollapsed state.

FIG. 2 is a schematic diagram of the same device, in a collapsed state.

FIG. 3 is a schematic diagram of the device according to one aspect of the invention, with attached computer system and interface control box.

FIG. 4 is a schematic diagram of a pneumatic type axial load gauge.

FIG. 5 is a schematic diagram of a lead-screw type axial load gauge.

### MODE(S) FOR CARRYING OUT THE INVENTION

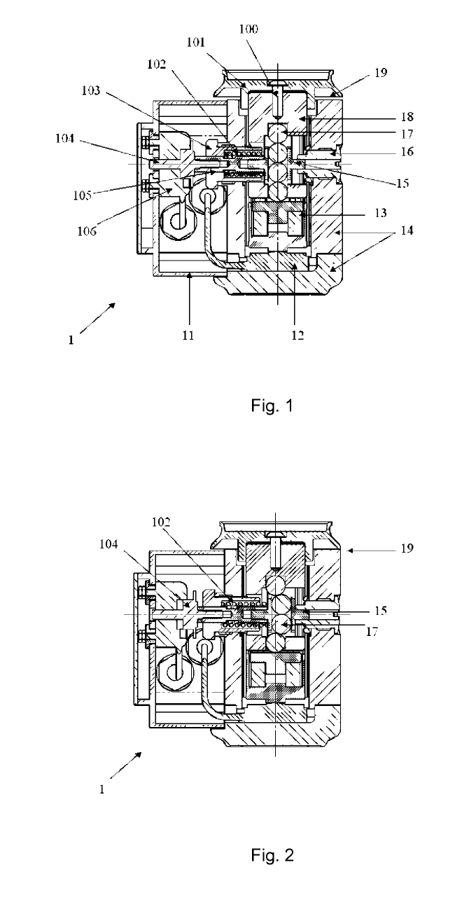

In FIG. 1, the device (1) comprises a chamber (14) with an axially moveable end wall (101) and within that chamber (14) is housed a collapsible mechanism (15, 17, 18), held in position by a plain bearing. The axially moveable end wall (101) is firmly attached to a hollow shaft (18) by way of a screw (100). The shaft accommodates a stack of rollers (17) aligned axially and the two middle rollers (17) are held in alignment by a cage (15) of two halves. One half of the cage (15) is radially moveable within a spacer bush (16). The other half of the cage (15) is also radially moveable and attached to a connecting rod (105), which serves to connect the cage (15) to a solenoid armature (104). The solenoid armature (104) is located radially within the solenoid coil (106) and the solenoid coil (106) is fixed to the solenoid housing (11) by two screws. Surrounding part of the connecting rod (105) and flush with the lip of the cage (15) is a coil spring (102). The connecting rod (105) is radially moveable within the solenoid bush (103). Beneath the shaft (18) sits a compliant element (13) contiguous a load cell (12).

In preparing the device for use, the solenoid is firstly energised and then it is armed; the operator mechanically manoeuvres the solenoid armature (104) toward the solenoid field located generally in the area of the solenoid coil (106) until the solenoid field engages and holds the solenoid armature (104) within. The device (1) is now primed ready for use.

When an axial load is applied to the device, the axially displaceable wall end (101) moves towards the chamber (14). The load is then transmitted through the stack of rollers (17) to the compliant element (13) and the device load cell (12). The device load cell (12) measures the magnitude of the load and ideally the device load cell (12) should be calibrated and traceable back to national standards.

At the required preset load, the solenoid coil (106) is de-energised with the effect that the solenoid armature (104), held firmly by the connecting rod (105) and together acting as if they were one single component, is displaced radially causing the coil spring (102) to decompress. The coil spring (102) thereby returns back to its natural stable state. Due to the action of the solenoid armature (104) and that of the coil spring (102), the cage (15) is forced to travel radially, moving the two middle rollers (17) out of alignment, as shown in FIG. 2. This causes the collapse of the internal mechanism and unloads the compliant element (13).

The load measured on the device load cell (12) is compared against the load measured on the gauge. It is this comparison that subsequently permits calibration of gauges relative to each another, within a factory or within an industry. Systematic comparisons can be used to investigate the repeatability and reproducibility of the gauge.

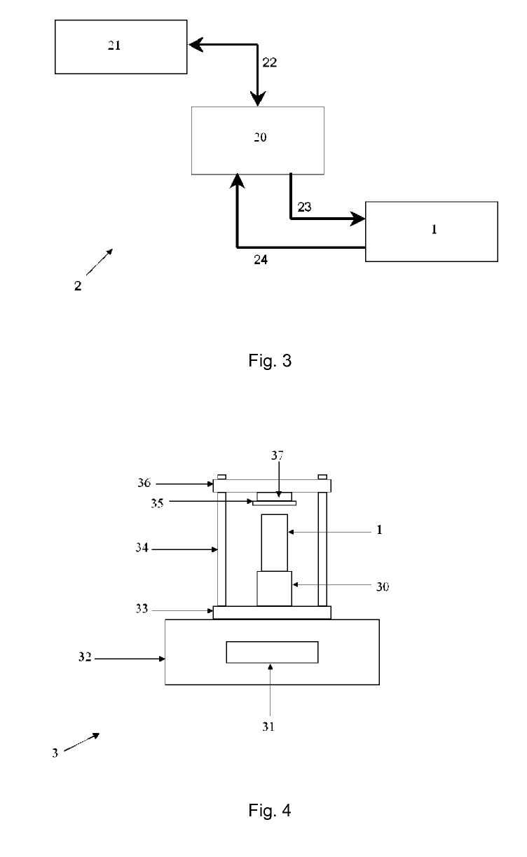

FIG. 3 shows how the device (1) is used in practice as part of a system. The computer (21) sends the desired load trip point to a comparator inside the control box (20) along a USB cable (22). When a load is measured on the load cell (12) within the device (1), a signal is transmitted along the signal lead (24) to the control box (20) and the comparator constantly compares the rising load against that of the desired load trip point. Once the desired load trip point has been reached, the output of the comparator is to de-energise the solenoid within the device (1) along a signal lead (23), thereby instigating collapse of the stack of rollers (17). A program running on the computer (21) records the measured load, typically in Newtons or kilograms, against time, together with the rate at which the load was reached. This rate can be significant when comparing different gauge types.

FIG. 4 shows an example of a pneumatic type axial load gauge. Such gauges are commercially available, for example, the CMC-Kuhnke® AXL-0500 Axial Load—Beverage Can Tester or the AXL-4000 Axial Load Tester from Canneed Instrument (HK) Ltd. In use, the device (1) is placed into the axial load gauge (3) and is placed on a support (30). The support (30) is gradually forced upwards towards and against the pressure plate (35). The time to run the test can be minimised by choosing appropriate spacers to reduce the free space. This is particularly useful when the same gauge (3) is used to test beverage cans of different volumes, ranging typically between 15 cl and 50 cl. The pressure plate (35) lies adjacent the gauge load cell (37), which is itself attached to the cross head (36). The pressure plate (35), gauge load cell (37) and cross head (36) are moveable vertically, guided by four columns (34) but are fixed in place for the purpose of testing. The control box (32) contains the electronics required to adjust the pneumatic supply taken from the factory air line to determine the applied load. The magnitude of the peak-applied load is communicated to the user on a display (31).

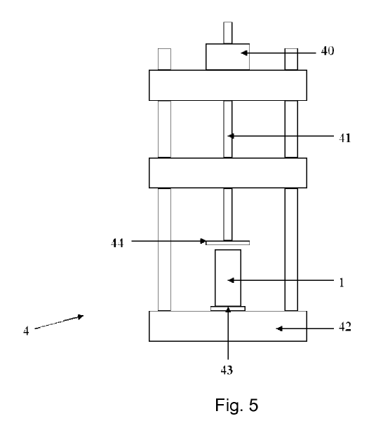

A typical lead-screw type axial load gauge (4) is shown in FIG. 5. These gauges are also widely available, for example from the likes of Mecmesin®. In this type of gauge, the load is applied by a downwardly advancing lead-screw (41) at the centre of the gauge, its displacement being effected by a motor (40) and controlled by electronics within the base (42). In use, the device (1) is placed directly onto the gauge load cell (43) and a load is transmitted to the device (1) from the gauge through a top platen (44).

It will be apparent that other configurations are possible without departing from the general scope of the invention as defined in the claims. For example, whilst a coil spring (120) has been used to assist the collapse of the collapsible mechanism, substitutes such as a disc spring or a pneumatic arrangement having the same function are possible.

1. A device for an axial load gauge comprising:
an interface for interfacing to the axial load gauge;
a collapsible mechanism;
a load cell;
whereby in use when a load is applied to the device, the applied load is transmitted through the device until a preset load value is reached, thereby activating collapse of the collapsible mechanism.

2. A device as claimed in claim 1, further comprising a chamber having an axially displaceable end wall.

3. A device as claimed in claim 1, wherein the collapsible mechanism includes a fluid bearing or a rolling element bearing.

4. A device as claimed in claim 3 wherein the rolling element bearing is a plurality of ball bearings or rollers.

5. A device as claimed in claim 1, wherein the load cell is in communication with the collapsible mechanism.

6. A device as claimed in claim 2, wherein the load cell is contiguous with an external surface of the chamber.

7. A device as claimed in claim 5, wherein the device further comprises a compliant element interposed between the load cell and the collapsible mechanism.

8. A device as claimed in claim 2, wherein the chamber and axially displaceable end wall are made of metal.

9. A device as claimed in claim 1, wherein the device is adapted for insertion into the axial load gauge vertically or horizontally or both.

10. A method of investigating the variability of an axial load gauge by use of a device as claimed in claim 1, the method comprising the following steps:
i. inserting the device into the axial load gauge;
ii. applying a load onto the device until collapse at a preset load;
iii. measuring the load returned by the gauge when the device collapses;
iv. comparing the collapse loads returned by the gauge with the preset collapse load of the device; and
v. repeating steps ii-iv as required.

11. The method of claim 10, wherein the operator is the same person for steps i-v.

12. The method of claim 10, wherein the method is repeated by at least two different operators.

13. (canceled)

14. A device as claimed in claim 6, wherein the device further comprises a compliant element interposed between the load cell and the collapsible mechanism.
